(19) United States
(12) Patent Application Publication
(10) Pub. No.: US 2017/0043826 A1
(43) Pub. Date: Feb. 16, 2017

(54) METHOD AND APPARATUS FOR LOCKING BICYCLE

(71) Applicants: Le Holdings(Beijing)Co., Ltd., Beijing (CN); LETV SPORTS CULTURE DEVELOP (BEIJING) CO., LTD., Beijing (CN)

(72) Inventor: Dalong LI, Beijing (CN)

(21) Appl. No.: 15/244,734

(22) Filed: Aug. 23, 2016

Related U.S. Application Data
(63) Continuation of application No. PCT/CN2016/082093, filed on May 13, 2016.

(30) Foreign Application Priority Data
Aug. 11, 2015 (CN) 201510491484.9

(51) Int. Cl. B62H 5/00; G01C 19/00; E05B 47/00; G01S 19/13; E05B 71/00; E05B 39/00

(52) U.S. Cl. CPC B62H 5/00; E05B 71/00; E05B 39/005; E05B 47/00; G01S 19/13; G01C 19/00

(57) ABSTRACT

Embodiments of the application provide a method and apparatus for locking a bicycle, the method including: if the bicycle is not locked, then obtaining a stationary length of time for which the bicycle has been stationary; and if the stationary length of time reaches a preset length of time threshold, then starting a lock on the bicycle to lock the bicycle. With the technical solutions according to the embodiments of the application, if the bicycle is not locked, then the length of time for which the bicycle has been stationary will be counted to thereby determine whether to lock the bicycle automatically instead of locking the bicycle manually so that the bicycle can be locked rapidly and conveniently; and the bicycle can be avoided from being lost because its rider forgets to lock the bicycle, thus further safeguarding the bicycle.

This application is a continuation of International Application No. PCT/CN2016/082093, with an international filing date of 13 May 2016, which is based upon and claims the priority to Chinese Patent Application No. 201510491484.9, filed on Aug. 11, 2015, the entire contents of all of which are incorporated herein by reference.

### TECHNICAL FIELD

The present application relates to the field of manufacturing a bicycle, and particularly to a method and apparatus for locking a bicycle.

### BACKGROUND

As our society is evolving, city traffic becomes increasingly loaded, and our sense of traveling in an environmentally friendly manner becomes increasingly growing, so that bicycles become increasingly popular. The bicycles convenient to ride, and friendly to our environment have been preferred by more and more citizens as their facility of transportation over a short distance because they can exercise while riding in an environmentally friendly manner; and since the bicycles are characterized by being low-weighted and portable, such a solution has become particularly important that addresses how to lock the bicycles to thereby prevent the bicycles from being lost.

An apparatus for locking a bicycle in the prior art tends to be structured like a traditional burglar-proof padlock, that is, if the bicycle is parked, then the rider will insert a bolt into a lock hole of the locking apparatus to thereby lock the bicycle. With this technical solution, the bicycle has to be locked manually, but if the user forgets to lock the bicycle, then he or her property may be lost.

As can be apparent, the bicycle in the prior art may suffer from the problems of being troublesome to lock, and poorly theft-proof performance.

### SUMMARY

Embodiments of the application provide a method and apparatus for locking a bicycle so as to address the problems of the bicycle in the prior art of being troublesome to lock, and poorly theft-proof performance.

Particular technical solutions according to the embodiments of the application are as follows: including:

obtaining a stationary length of time for which the bicycle has been stationary, wherein the bicycle is not locked; and the stationary length of time characterizes a length of time between a point of time when the bicycle becomes stationary, and a current point of time; and

if the stationary length of time reaches a preset length of time threshold, then starting a lock on the bicycle to lock the bicycle.

An embodiment of the application provides an apparatus for locking a bicycle, the apparatus including:

a stationary length of time obtaining unit configured to obtain a stationary length of time for which the bicycle has been stationary, wherein the bicycle is not locked; and the stationary length of time characterizes a length of time between a point of time when the bicycle becomes stationary, and a current point of time; and

a locking unit configured to start a lock on the bicycle to lock the bicycle, if the stationary length of time reaches a preset length of time threshold.

In the embodiments of the application, if the bicycle is not locked, then the stationary length of time for which the bicycle has been stationary will be obtained; and if the stationary length of time reaches the preset length of time threshold, then the lock on the bicycle will be started to lock the bicycle. With the technical solutions according to the embodiments of the application, if the bicycle is not locked, then the length of time for which the bicycle has been stationary will be counted to thereby determine whether to lock the bicycle automatically instead of locking the bicycle manually so that the bicycle can be locked rapidly and conveniently; and the bicycle can be avoided from being lost because its rider forgets to lock the bicycle, thus further safeguarding the bicycle.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of locking a bicycle according to some embodiments;

FIG. 2 is a flow chart of locking a bicycle according to some embodiments;

FIG. 3 is a schematic structural diagram of an apparatus for locking a bicycle according to some embodiments;

FIG. 4 is a schematic structural diagram of another apparatus for locking a bicycle according to some embodiments; and

FIG. 5 is a schematic structural diagram of a bicycle according to some embodiments.

### DETAILED DESCRIPTION

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

The embodiments of the application will be described below in further details with reference to the drawings.

### First Embodiment

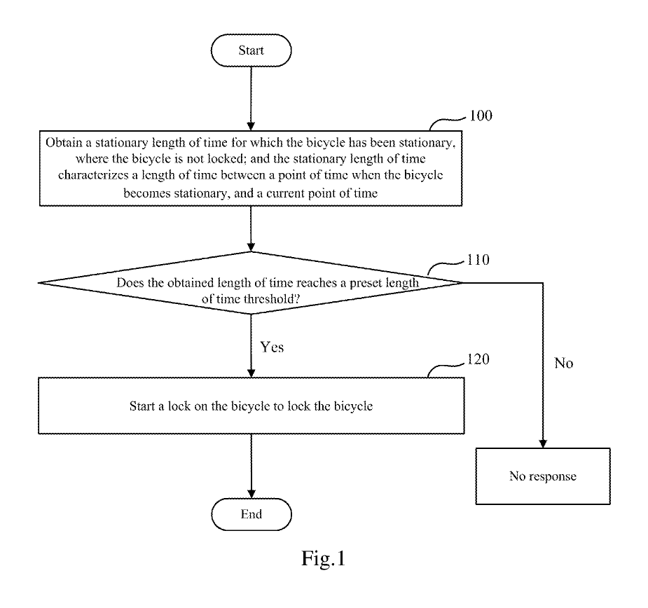

Referring to FIG. 1, in an embodiment of the application, if a bicycle is not locked by its user, then a lock can be triggered automatically to lock the bicycle so as to safeguard the bicycle, particularly in the following steps:

The step 100 is to obtain a stationary length of time for which the bicycle has been stationary, where the bicycle is not locked; and the stationary length of time characterizes a length of time between a point of time when the bicycle becomes stationary, and a current point of time.

In an embodiment of the application, it can be determined whether the bicycle is stationary, in the following three approaches to thereby determine the point of time when the bicycle becomes stationary; and particularly the bicycle determines whether the bicycle is stationary, according to whether an angle at which the body of the bicycle is inclined is changed; the bicycle determines whether the bicycle is stationary, according to whether a position of the bicycle is changed; and the bicycle determines whether the bicycle is stationary, according to whether a speed of the bicycle is zero.

In the first approach, the bicycle can include a gyroscope, so that the bicycle obtains an angular speed of the bicycle using the gyroscope, and temporally integrates the angular angle to obtain angles at which the body of the bicycle is inclined at different points of time; that is, the bicycle obtains a first inclination angle at which the body of the bicycle is inclined at a first point of time, and a second inclination angle at which the body of the bicycle is inclined at a second point of time, and if the first inclination angle is the same as the second inclination angle, then it will be determined that the bicycle is stationary; and the first point of time will be determined as the point of time at which the bicycle becomes stationary; where the first point of time is earlier than the second point of time, and the temporal difference between the first point of time and the second point of time can be preset for a particular application scenario.

Optionally the gyroscope is a three-axis gyroscope, and with this technical solution, the gyroscope can detect angular variations of the bicycle in respective directions.

Optionally the gyroscope is a laser gyroscope, and since the laser gyroscope is highly accurate, the laser gyroscope can be used to thereby improve the accuracy of a detection result; or the gyroscope can be a micro electrical-mechanical gyroscope, and since the micro electrical-mechanical gyroscope has the advantages of being highly integrated, and a small volume, the micro electrical-mechanical gyroscope can be used to thereby improve the integration of the bicycle.

Preferably the gyroscope is located at the weight center of the bicycle so that a detection result of the gyroscope can be prevented from being affected by a centrifugal force while the bicycle is being ridden, to thereby improve the accuracy of the detection result.

With the technical solution above, the angular speed of the bicycle can be obtained using the gyroscope installed in the bicycle, and the angle at which the body of the bicycle is inclined can be obtained from the angular speed, to thereby determine whether the bicycle is stationary; and since the gyroscope is a precise device, the state of the bicycle can be determined more precisely using the gyroscope.

In the second approach, the bicycle can include a positional information obtaining unit, so that the bicycle obtains positional information of the bicycle using the positional information obtaining unit; that is, the bicycle obtains first positional information at a first point of time, and second positional information at a second point of time, and if the first positional information is the same as the second positional information, then it will be determined that the bicycle is stationary; and the first point of time will be determined as the point of time at which the bicycle becomes stationary; where the first point of time is earlier than the second point of time, and the temporal difference between the first point of time and the second point of time can be preset for a particular application scenario.

Optionally current positional information of the bicycle can be obtained by a positional information obtaining unit in the bicycle, which can include a satellite positioning system (e.g., the Global Positioning System (GPS), the Global Navigation Satellite System (GLONASS), the Beidou Navigation System, etc.) and its corresponding peripheral devices

With the technical solution, the positional information of the bicycle can be detected by the GPS device, and it can be determined whether to lock the bicycle, according to whether the positional information of the bicycle at different points of time is changed, thus locking the bicycle simply, rapidly and conveniently; and since the GPS device is an accurately positioning device, the GPS device can be used to thereby improve the accuracy of locking the bicycle.

In the third approach, the bicycle can further include a speed sensor, so that the bicycle can obtain the speed of the bicycle using the speed sensor; and if the speed is zero, then it will be determined that the bicycle is stationary.

In an embodiment of the application, the bicycle can further include a timer, so that if it is determined that the bicycle becomes stationary, then the timer will be started to record the length of time from when the bicycle becomes stationary to the current point of time.

The step 110 is to determine whether the recorded length of time reaches a preset length of time threshold, and if so, to proceed to the step 120; otherwise, the bicycle will not respond.

In an embodiment of the application, the bicycle compares in real time the length of time recorded by the timer with the preset length of time threshold, and determines whether to lock the bicycle, according to a comparison result.

The step 120 is to start a lock on the bicycle to lock the bicycle.

In an embodiment of the application, the lock of the bicycle is fixed in the bicycle, or can be an electromagnetic lock connected with the bicycle under the electromagnetic principle, where the electromagnetic lock can be removed from the bicycle and installed on another vehicle (e.g., another bicycle, an automobile, etc.) to thereby improve the flexibility of accessing the lock.

Optionally the bicycle further includes a power source unit configured to power the respective function units, the lock, and other components in the bicycle.

With the technical solution according to the embodiment of the application, if the bicycle is not locked, then the length of time for which the bicycle has been stationary will be counted to thereby determine whether to lock the bicycle automatically so as to avoid the bicycle from being lost because the user forgets to lock the bicycle, thus further safeguarding the bicycle.

### Second Embodiment

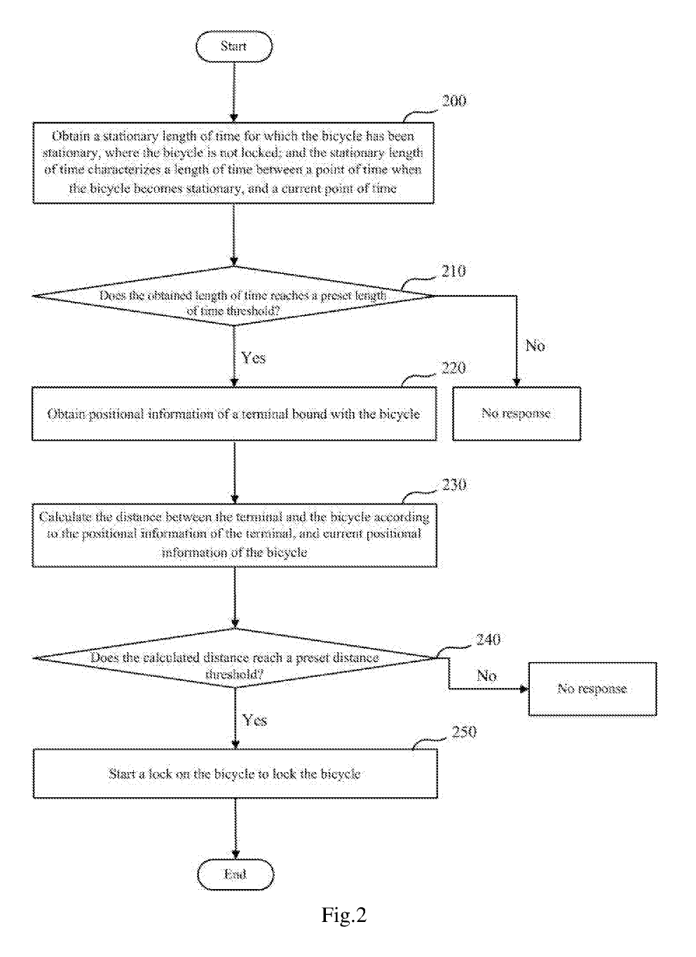

Referring to FIG. 2, in an embodiment of the application, if a bicycle is not locked by its user, then a lock can be triggered automatically to lock the bicycle so as to safeguard the bicycle, particularly in the following steps:

The step 200 is to obtain a stationary length of time for which the bicycle has been stationary, where the bicycle is not locked; and the stationary length of time characterizes a length of time between a point of time when the bicycle becomes stationary, and a current point of time.

In an embodiment of the application, the bicycle can determine the point of time when the bicycle becomes stationary, using a gyroscope; or can determine the point of time when the bicycle becomes stationary, using a positional information obtaining unit; or can determine the point of time when the bicycle becomes stationary, using a speed sensor.

Optionally the gyroscope is a three-axis gyroscope, and with this technical solution, the gyroscope can detect angular variations of the bicycle in respective directions.

Optionally the gyroscope is a laser gyroscope, and since the laser gyroscope is highly accurate, the laser gyroscope can be used to thereby improve the accuracy of a detection result; or the gyroscope can be a micro electrical-mechanical gyroscope, and since the micro electrical-mechanical gyroscope has the advantages of being highly integrated, and a small volume, the micro electrical-mechanical gyroscope can be used to thereby improve the integration of the bicycle.

Preferably the gyroscope is located at the weight center of the bicycle so that a detection result of the gyroscope can be prevented from being affected by a centrifugal force while the bicycle is being ridden, to thereby improve the accuracy of the detection result.

Optionally current positional information of the bicycle can be obtained by a positional information obtaining unit in the bicycle, which can include a satellite positioning system (e.g., the GPS, the GLONASS, the Beidou Navigation System, etc.) and its corresponding peripheral devices.

The step 210 is to determine whether the obtained length of time reaches a preset length of time threshold, and if so, to proceed to the step 220; otherwise, the bicycle will not respond.

In an embodiment of the application, the bicycle can further include a timer so that if it is determined that the bicycle becomes stationary, then the timer will be started to record the length of time from when the bicycle becomes stationary to the current point of time, and the bicycle can compare in real time the length of time recorded by the timer with the preset length of time threshold, and proceed to the step 220 upon determining that the recorded length of time reaches the preset length of time threshold.

The step 220 is to obtain positional information of a terminal bound with the bicycle.

In an embodiment of the application, the terminal bound with the bicycle includes a positioning device which can be embodied by a GPS device, or a GPS device and a gyroscope.

Optionally the terminal bound with the bicycle includes a communicating unit configured to transmit the positional information obtained by the positioning device to the bicycle.

Optionally the bicycle exchanges information with the terminal bound with the bicycle through Bluetooth; or exchanges information with the terminal bound with the bicycle through infrareds; or exchanges information with the terminal bound with the bicycle over a wireless network.

The step 230 is to calculate the distance between the terminal and the bicycle according to the positional information of the terminal, and current positional information of the bicycle.

In an embodiment of the application, the current positional information of the bicycle can be obtained by a positional information obtaining unit in the bicycle, which can include a satellite positioning system (e.g., the GPS, the GLONASS, the Beidou Navigation System, etc.) and its corresponding peripheral devices.

Optionally the positional information obtaining unit of the bicycle can further include an acceleration meter so that the bicycle can be positioned using the gyroscope and the acceleration meter. Particularly the gyroscope determines an angular speed of the moving bicycle, temporally integrates the angular speed, and determines an inclination angle at which the moving bicycle is inclined; and the acceleration meter calculates an acceleration of the bicycle from the inclination angle, so that a distance over which and a direction in which the bicycle moves is determined according to the acceleration of the bicycle, and the current positional information of the bicycle is obtained according to initial positional information of the bicycle, and the distance over which and the direction in which the bicycle moves, where the direction in which the bicycle moves can be determined by the direction of the acceleration, which is determined by the direction of the angular speed obtained by the gyroscope; and the distance over which the bicycle moves can be determined in the equation of:

s=v₀t+at²,

Where s represents the distance over which the bicycle moves; v₀ represents an initial speed which is zero because the bicycle is locked; a represents the acceleration obtained by the acceleration meter; and t represents a length of time for which the bicycle has moved.

Optionally the gyroscope can be a laser gyroscope, and since the laser gyroscope is highly accurate, the laser gyroscope can be used to assist in positioning the bicycle so as to improve the accuracy of a positioning result; or the gyroscope can be a micro electrical-mechanical gyroscope, and since the micro electrical-mechanical gyroscope has the advantages of being highly integrated, and a small volume, the micro electrical-mechanical gyroscope can be used to assist in positioning the bicycle so as to improve the integration of the bicycle.

Optionally the gyroscope is a three-axis gyroscope, and with this technical solution, the gyroscope can detect angular variations of the bicycle in respective directions.

With the technical solution above, the bicycle can be positioned using the gyroscope and the acceleration meter even in a GPS-disabled environment (e.g., a tunnel, etc.) to thereby avoid such a situation from occurring that the current positional information of the bicycle is unavailable due to the environmental factor so as to improve the reliability of obtaining the positional information of the bicycle.

The step 240 is to determine whether the calculated distance reaches a preset distance threshold, and if so, to proceed to the step 250; otherwise, the bicycle will not respond.

The step 250 is to start the lock on the bicycle to lock the bicycle.

In an embodiment of the application, the lock of the bicycle is fixed in the bicycle, or can be an electromagnetic lock connected with the bicycle under the electromagnetic principle, where the electromagnetic lock can be removed from the bicycle and installed on another vehicle (e.g., another bicycle, an automobile, etc.) to thereby improve the flexibility of accessing the lock.

Furthermore the bicycle can alternatively determine firstly the distance, and then the stationary length of time, that is, if it is determined that the distance between the bicycle and the terminal bound with the bicycle reaches the preset distance threshold, then if it is determined that the length of time for which the bicycle has been stationary reaches the preset length of time threshold, then the bicycle will be locked, and a repeated description thereof will be omitted here.

With the technical solution according to the embodiment of the application, if the bicycle is not locked, then both the length of time for which the bicycle has been stationary will be determined, and the distance between the bicycle and the terminal will be counted to thereby determine whether to lock the bicycle automatically so as to avoid the bicycle from being lost because the user forgets to lock the bicycle, thus further safeguarding the bicycle.

### Third Embodiment

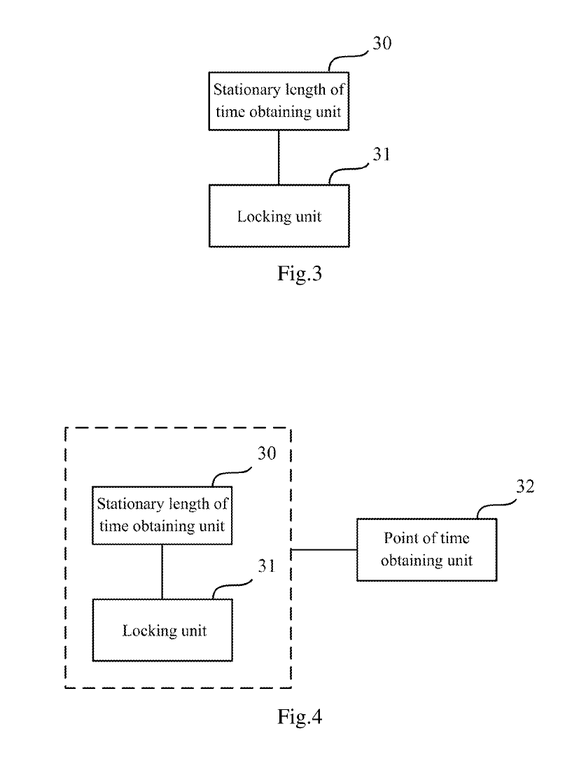

Based upon the technical solutions above, referring to FIG. 3, an embodiment of the application further provides an apparatus for locking a bicycle, which includes a stationary length of time obtaining unit 30, and a locking unit 31, where:

The stationary length of time obtaining unit 30 is configured to obtain a stationary length of time for which the bicycle has been stationary, where the bicycle is not locked; and the stationary length of time characterizes a length of time between a point of time when the bicycle becomes stationary, and a current point of time; and

The locking unit 31 is configured to start a lock on the bicycle to lock the bicycle, if the stationary length of time reaches a preset length of time threshold.

Optionally the stationary length of time obtaining unit 30 is configured to record the length of time from the point of time when the bicycle becomes stationary to the current point of time using a timer; and to determine the obtained length of time as the stationary length of time for which the bicycle has been stationary.

Furthermore the locking unit 31 is further configured, after the stationary length of time reaches the preset length of time threshold, and before the lock on the bicycle is started, to obtain positional information of a terminal bound with the bicycle; to calculate the distance between the terminal and the bicycle according to the positional information of the terminal, and current positional information of the bicycle; and to determine that the calculated distance reaches a preset distance threshold.

Furthermore referring to FIG. 4, the apparatus further includes a point of time obtaining unit 32 configured to determine the point of time when the bicycle becomes stationary, using a gyroscope; or to determine the point of time when the bicycle becomes stationary, using a Global Positioning System (GPS); or to determine the point of time when the bicycle becomes stationary, using a speed sensor.

Optionally the point of time obtaining unit 32 configured to determine the point of time when the bicycle becomes stationary, using the gyroscope is configured: to detect a first angular speed of the bicycle using the gyroscope at a first point of time, and to obtain a first angle at which the body of the bicycle is inclined, according to the first angular speed; to detect a second angular speed of the bicycle using the gyroscope at a second point of time, and to obtain a second angle at which the body of the bicycle is inclined, according to the second angular speed, where the first point of time is earlier than the second point of time, and the temporal difference between the first point of time and the second point of time is a preset value; and if the first angle at which the body of the bicycle is inclined is the same as the second angle at which the body of the bicycle is inclined, to determine the first point of time as the point of time when the bicycle becomes stationary.

Optionally the point of time obtaining unit 32 configured to determine the point of time when the bicycle becomes stationary using the GPS is configured: to obtain first positional information of the bicycle using the GPS at a first point of time; to obtain second positional information of the bicycle using the GPS at a second point of time, where the first point of time is earlier than the second point of time, and the temporal difference between the first point of time and the second point of time is a preset value; and if the first positional information is the same as the second positional information, to determine the first point of time as the point of time when the bicycle becomes stationary.

Optionally the point of time obtaining unit 32 configured to determine the point of time when the bicycle becomes stationary using the speed sensor is configured: to obtain a speed of the bicycle using the speed sensor at any point of time; and if the speed of the bicycle is zero, to determine the any one point of time as the point of time when the bicycle becomes stationary.

### Fourth Embodiment

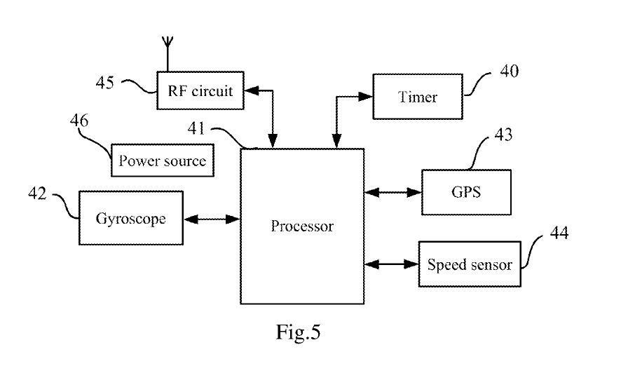

Based upon the technical solutions above, referring to FIG. 5, an embodiment of the application further provides a bicycle including a timer 40 and a processor 41, where:

The timer 40 is configured to obtain a stationary length of time for which the bicycle has been stationary, where the bicycle is not locked; and the stationary length of time characterizes a length of time between a point of time when the bicycle becomes stationary, and a current point of time; and

The processor 41 is configured to start a lock on the bicycle to lock the bicycle, if the stationary length of time reaches a preset length of time threshold.

Furthermore the bicycle includes a gyroscope configured to detect a first angular speed of the bicycle at a first point of time, and to obtain a first angle at which the body of the bicycle is inclined, according to the first angular speed; and to detect a second angular speed of the bicycle at a second point of time, and to obtain a second angle at which the body of the bicycle is inclined, according to the second angular speed; and

The processor 41 is configured, if the first angle at which the body of the bicycle is inclined is the same as the second angle at which the body of the bicycle is inclined, to determine the first point of time as the point of time when the bicycle becomes stationary.

Optionally the gyroscope 42 can be a laser gyroscope, and since the laser gyroscope is highly accurate, the laser gyroscope can be used to thereby improve the accuracy of a detection result; or the gyroscope 42 can be a micro electrical-mechanical gyroscope, and since the micro electrical-mechanical gyroscope has the advantages of being highly integrated, and a small volume, the micro electrical-mechanical gyroscope can be used to thereby improve the integration of the bicycle.

Optionally the gyroscope 42 is a three-axis gyroscope, and with this technical solution, the gyroscope 42 can detect angular variations of the bicycle in respective directions.

Preferably the gyroscope 42 is located at the weight center of the bicycle so that a detection result of the gyroscope 42 can be prevented from being affected by a centrifugal force while the bicycle is being ridden, to thereby improve the accuracy of the detection result.

Furthermore the bicycle further includes a GPS 43 configured to obtain first positional information of the bicycle at a first point of time; and to obtain second positional information of the bicycle at a second point of time, where the first point of time is earlier than the second point of time, and the temporal difference between the first point of time and the second point of time is a preset value; and

The processor 41 is configured, if the first positional information is the same as the second positional information, to determine the first point of time as the point of time when the bicycle becomes stationary.

Furthermore the bicycle further includes a speed sensor 44 configured to obtain a speed of the bicycle at any one point of time.

The processor 41 is configured, if the speed of the bicycle is zero, to determine the any one point of time as the point of time when the bicycle becomes stationary.

Optionally the bicycle further includes an RF circuit 45 configured to exchange information with the terminal bound with the bicycle through Bluetooth; or to exchange information with the terminal bound with the bicycle through infrareds; or to exchange information with the terminal bound with the bicycle over a wireless network.

Optionally the RF circuit 45 is configured to receive positional information of a terminal bound with the bicycle; and the processor 41 is configured, after the stationary length of time reaches the preset length of time threshold, and before the lock on the bicycle is started, to calculate the distance between the terminal and the bicycle according to the positional information of the terminal, and current positional information of the bicycle; and to determine that the calculated distance reaches a preset distance threshold.

Further, the bicycle further includes a power source 46 configured to power the respective components in the bicycle.

In summary, in the embodiments of the application, the stationary length of time for which the bicycle has been stationary is obtained, and if the stationary length of time reaches the preset length of time threshold, then the lock on the bicycle will be started to lock the bicycle; or the positional information of the terminal bound with the bicycle is obtained, the distance between the terminal and the bicycle is calculated according to the positional information of the terminal, and the current positional information of the bicycle; and if the calculated distance reaches the preset distance threshold, then the lock on the bicycle will be started to lock the bicycle. With the technical solutions according to the embodiments of the application, if the bicycle is not locked, then the length of time for which the bicycle has been stationary, or the distance between the terminal and the terminal will be counted to thereby determine whether to lock the bicycle automatically so as to avoid the bicycle from being lost because the user forgets to lock the bicycle, thus further safeguarding the bicycle.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the application. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

What is claimed is:

1. A method for locking a bicycle, the method comprising:
obtaining a stationary length of time for which the bicycle has been stationary, wherein the bicycle is not locked; and the stationary length of time characterizes a length of time between a point of time when the bicycle becomes stationary, and a current point of time; and
if the stationary length of time reaches a preset length of time threshold, then starting a lock on the bicycle to lock the bicycle.

2. The method according to claim 1, wherein determining the point of time when the bicycle becomes stationary comprises:
determining the point of time when the bicycle becomes stationary, using a gyroscope; or
determining the point of time when the bicycle becomes stationary, using a Global Positioning System (GPS); or
determining the point of time when the bicycle becomes stationary, using a speed sensor.

3. The method according to claim 2, wherein determining the point of time when the bicycle becomes stationary using the gyroscope comprises:
detecting a first angular speed of the bicycle using the gyroscope at a first point of time, and obtaining a first angle at which the body of the bicycle is inclined, according to the first angular speed;
detecting a second angular speed of the bicycle using the gyroscope at a second point of time, and obtaining a second angle at which the body of the bicycle is inclined, according to the second angular speed, wherein the first point of time is earlier than the second point of time, and the temporal difference between the first point of time and the second point of time is a preset value; and
if the first angle at which the body of the bicycle is inclined is the same as the second angle at which the body of the bicycle is inclined, then determining the first point of time as the point of time when the bicycle becomes stationary.

4. The method according to claim 2, wherein determining the point of time when the bicycle becomes stationary using the GPS comprises:
obtaining first positional information of the bicycle using the GPS at a first point of time;
obtaining second positional information of the bicycle using the GPS at a second point of time, wherein the first point of time is earlier than the second point of time, and the temporal difference between the first point of time and the second point of time is a preset value; and
if the first positional information is the same as the second positional information, then determining the first point of time as the point of time when the bicycle becomes stationary.

5. The method according to claim 2, wherein determining the point of time when the bicycle becomes stationary using the speed sensor comprises:
obtaining a speed of the bicycle using the speed sensor at any point of time; and
if the speed of the bicycle is zero, then determining the any one point of time as the point of time when the bicycle becomes stationary.

6. The method according to claim 1, wherein obtaining the stationary length of time for which the bicycle has been stationary comprises:
recording the length of time from the point of time when the bicycle becomes stationary to the current point of time using a timer; and
determining the recorded length of time as the stationary length of time for which the bicycle has been stationary.

7. The method according to claim 1, wherein after the stationary length of time reaches the preset length of time threshold, and before the lock on the bicycle is started, the method further comprises:
obtaining positional information of a terminal bound with the bicycle;
calculating the distance between the terminal and the bicycle according to the positional information of the terminal, and current positional information of the bicycle; and
determining that the calculated distance reaches a preset distance threshold.

8. The method according to claim 2, wherein obtaining the stationary length of time for which the bicycle has been stationary comprises:
recording the length of time from the point of time when the bicycle becomes stationary to the current point of time using a timer; and
determining the recorded length of time as the stationary length of time for which the bicycle has been stationary.

9. The method according to claim 3, wherein obtaining the stationary length of time for which the bicycle has been stationary comprises:
recording the length of time from the point of time when the bicycle becomes stationary to the current point of time using a timer; and
determining the recorded length of time as the stationary length of time for which the bicycle has been stationary.

10. The method according to claim 4, wherein obtaining the stationary length of time for which the bicycle has been stationary comprises:
recording the length of time from the point of time when the bicycle becomes stationary to the current point of time using a timer; and
determining the recorded length of time as the stationary length of time for which the bicycle has been stationary.

11. The method according to claim 5, wherein obtaining the stationary length of time for which the bicycle has been stationary comprises:
recording the length of time from the point of time when the bicycle becomes stationary to the current point of time using a timer; and
determining the recorded length of time as the stationary length of time for which the bicycle has been stationary.

12. An apparatus for locking a bicycle, the apparatus comprising:
a stationary length of time obtaining unit configured to obtain a stationary length of time for which the bicycle has been stationary, wherein the bicycle is not locked; and the stationary length of time characterizes a length of time between a point of time when the bicycle becomes stationary, and a current point of time; and
a locking unit configured to start a lock on the bicycle to lock the bicycle, if the stationary length of time reaches a preset length of time threshold.

13. The apparatus according to claim 12, wherein the apparatus further comprises a point of time obtaining unit configured:
to determine the point of time when the bicycle becomes stationary, using a gyroscope; or
to determine the point of time when the bicycle becomes stationary, using a Global Positioning System (GPS); or
to determine the point of time when the bicycle becomes stationary, using a speed sensor.

14. The apparatus according to claim 13, wherein the point of time obtaining unit configured to determine the point of time when the bicycle becomes stationary, using the gyroscope is configured:
to detect a first angular speed of the bicycle using the gyroscope at a first point of time, and to obtain a first angle at which the body of the bicycle is inclined, according to the first angular speed;
to detect a second angular speed of the bicycle using the gyroscope at a second point of time, and to obtain a second angle at which the body of the bicycle is inclined, according to the second angular speed, wherein the first point of time is earlier than the second point of time, and the temporal difference between the first point of time and the second point of time is a preset value; and
if the first angle at which the body of the bicycle is inclined is the same as the second angle at which the body of the bicycle is inclined, to determine the first point of time as the point of time when the bicycle becomes stationary.

15. The apparatus according to claim 13, wherein the point of time obtaining unit configured to determine the point of time when the bicycle becomes stationary using the GPS is configured:
to obtain first positional information of the bicycle using the GPS at a first point of time;
to obtain second positional information of the bicycle using the GPS at a second point of time, wherein the first point of time is earlier than the second point of time, and the temporal difference between the first point of time and the second point of time is a preset value; and
if the first positional information is the same as the second positional information, to determine the first point of time as the point of time when the bicycle becomes stationary.

16. The apparatus according to claim 13, wherein the point of time obtaining unit configured to determine the point of time when the bicycle becomes stationary using the speed sensor is configured:
to obtain a speed of the bicycle using the speed sensor at any point of time; and if the speed of the bicycle is zero, to determine the any one point of time as the point of time when the bicycle becomes stationary.

17. The apparatus according to claim 12, wherein the stationary length of time obtaining unit is configured:
to record the length of time from the point of time when the bicycle becomes stationary to the current point of time using a timer; and
to determine the recorded length of time as the stationary length of time for which the bicycle has been stationary.

18. The apparatus according to claim 13, wherein the locking unit is configured, after the stationary length of time reaches the preset length of time threshold, and before the lock on the bicycle is started:
to obtain positional information of a terminal bound with the bicycle;
to calculate the distance between the terminal and the bicycle according to the positional information of the terminal, and current positional information of the bicycle; and
to determine that the calculated distance reaches a preset distance threshold.

19. The apparatus according to claim 13, wherein the stationary length of time obtaining unit is configured:
to record the length of time from the point of time when the bicycle becomes stationary to the current point of time using a timer; and
to determine the recorded length of time as the stationary length of time for which the bicycle has been stationary.

20. The apparatus according to claim 14, wherein the stationary length of time obtaining unit is configured:
to record the length of time from the point of time when the bicycle becomes stationary to the current point of time using a timer; and
to determine the recorded length of time as the stationary length of time for which the bicycle has been stationary.
